(19) United States
(12) Patent Application Publication
(10) Pub. No.: US 2001/0038364 A1
(43) Pub. Date: Nov. 8, 2001

(54) Display panel and driving method therefor

(76) Inventors: Atsushi Ito, Tokyo (JP); Hironobu Arimoto, Tokyo (JP)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/905,970

(22) Filed: Jul. 17, 2001

Related U.S. Application Data
(62) Division of application No. 09/321,564, filed on May 28, 1999.

(30) Foreign Application Priority Data
Oct. 30, 1998 (JP) 10-309963

(51) Int. Cl. G09G 3/20

(52) U.S. Cl. 345/55

(57) ABSTRACT

The present invention is concerned with a display panel having display cells, each of which is discharged to glow by means of paired cell-by-cell common electrodes and a discrete electrode, set in array, and a driving method for the display panel. An object of the present invention is to decrease the number of discrete contacts linked to the discrete electrodes so that the display cells can be driven discretely. Another object thereof is to define time domains, during which a plurality of common electrodes is controlled, within the period of a unit sequence so that the display cells can be driven discretely.

A display panel has common electrodes, a plurality of cell-by-cell common electrodes, and discrete electrodes. The common electrodes are extending in columns on a transparent substrate. The cell-by-cell common electrodes are extending in rows from the common electrodes. The discrete electrodes are located among the adjoining cell-by-cell common electrodes on the transparent substrate. Display cells each of which is discharged to glow by means of paired cell-by-cell common electrodes and a discrete electrode are arranged in the display panel. According to a driving method for the display panel, the cell-by-cell common electrodes are interposed between the plurality of adjoining common electrodes. The discrete electrodes are located successively over display cells adjoining in rows. Time domains are determined during which display pulses are applied sequentially to the plurality of common electrodes. A unit sequence is completed over the time domains. Discharge control pulses are applied to the discrete electrodes. Thus, the display cells are lit or unlit.

### BACKGROUND OF THE INVENTION

1. Field of the Invention

The present invention relates to a display panel for displaying pictures or the like, and a driving method for the display panel.

2. Description of the Related Art

In the past, a display panel for displaying pictures by utilizing gas discharge has been described in, for example, “Plasma Display” written by Ohwaki and Yoshida (November of 1983). In the display panel, comb electrodes coated with an insulating material such as glass are opposed to each other in the form of a matrix with a discharge space between them. Display cells arranged in the form of a matrix are driven concurrently by a single comb electrode. Moreover, for controlling display on the conventional display panel, the comb electrodes arranged in the form of a matrix are used to successively drive the electrodes of the comb electrode juxtaposed coincidentally with scanning lines. Microscopic discharge is induced in display cells formed between the selected electrodes of the comb electrode and electrodes of the other comb electrode opposed in the form of a matrix. This is a writing operation. The display cells in which microscopic discharge has been induced by the writing operation are selectively caused to glow. Nevertheless, the whole display screen is caused to glow. This is a sustaining operation. Broadly, display is achieved by performing these two operations.

The conventional display panel has the foregoing structure. The electrodes arranged in the form of a matrix concurrently drive a plurality of display cells numbering 100 or more. Wall charges or space charges on the electrodes affect the other cells on the same electrodes. Consequently, a large difference in performance between one product and another is created in the process of manufacturing. Display cannot therefore help being controlled depending on the properties of display cells to be discharged. A control margin is therefore not large enough to stabilize display. Moreover, this poses a problem in that the yield of manufacturing the display panel is lowered duly.

Moreover, according to a conventional driving method for display panels, a luminance must be controlled for each display cell in order to display a picture. Since display electrodes are in charge of numerous display cells, a special procedure must be adopted for visualizing gradation. Furthermore, according to a conventional gradation control mode for display panels, luminance cannot be varied continuously. Points exhibiting discontinuous gradation, which result in a so-called pseudo contour, are visualized. This leads to greatly degraded quality of picture display.

### SUMMARY OF THE INVENTION

The present invention attempts to solve the foregoing problems. Discrete contacts are led out from display cells so that the display cells can be driven discretely. The same number of bits as the number of cells is needed in terms of circuitry. This leads to an increase in number of ICs employed and an increase in number of discrete contacts. In consideration of this situation, an object of the present invention is to provide a display panel having a simple configuration that includes a reduced number of discrete contacts. In the display panel, cell-by-cell common electrodes included in the display cells are connected to a plurality of common electrodes. Discrete electrodes included in the display cells are extending successively between the plurality of common electrodes. The object of the present invention is to also provide a driving method for the display panel enabling discrete driving of each display cell. According to the driving method, time domains during which the plurality of common electrodes is controlled respectively are determined within the period of a unit sequence.

A display panel set forth in the first aspect of the present invention includes common electrodes, a plurality of cell-by-cell common electrodes, and discrete electrodes. The common electrodes are extending in columns on a transparent substrate. The plurality of cell-by-cell common electrodes is extending in rows from the common electrodes. The discrete electrodes are located among the adjoining cell-by-cell common electrodes on the transparent substrate. Each of display cells set in array is discharged to glow by means of paired cell-by-cell common electrodes and a discrete electrode. In the display panel, the cell-by-cell common electrodes are located between the plurality of adjoining common electrodes. The discrete electrodes are located successively over display cells mutually adjoining in rows.

A display panel set forth in the second aspect of the present invention is subordinate to the one described in the first aspect. In the display panel, discrete contacts are located at the center nodes of the successive discrete electrodes. The common electrodes are connected to common contacts.

A display panel set forth in the third aspect of the present invention is subordinate to the one described in the first aspect. Herein, common electrode portions are extending along both columnar edges of the transparent substrate. Common electrodes are connected alternately to the common electrode portions.

A driving method for a display panel set forth in the fourth aspect of the present invention is adaptable to a display panel in which: one common electrode and the other common electrode are opposed to each other and extending in columns; a plurality of cell-by-cell common electrodes are extending in rows from the one common electrode and the other common electrode; and a plurality of discrete electrodes are extending in rows among the cell-by-cell common electrodes. A plurality of display cells set in array is each discharged to glow by means of paired cell-by-cell common electrodes and a discrete electrode. The discrete electrodes are located successively over display cells adjoining in rows. According to the driving method, one time domain and the other time domain during which display pulses are applied consecutively to the one common electrode and the other common electrode respectively are determined in order to achieve a unit sequence. Discharge control pulses are applied to the discrete electrodes. Thus, the display cells on the plurality of rows are lit or unlit.

A driving method for display panels set forth in the fifth aspect of the present invention is subordinate to the one described in the fourth aspect. Herein, the display pulses are composite voltage pulses that become equal to or higher than a discharge start voltage after having a voltage pulse equal to or lower than the discharge start voltage superposed thereon during the duration of the voltage pulse. The pulse widths of the discharge control pulses are controlled in order to control whether display cells should be unlit.

A driving method for display panels set forth in the sixth aspect of the present invention is subordinate to the one described in the fifth aspect. Herein, a plurality of display pulses is applied during the time domains during which the display pulses are applied to the one common electrode and the other common electrode respectively.

In a display panel set forth in the seventh aspect of the present invention, each of dots arranged in the form of a matrix is rendered by four display cells arranged in two rows and two columns. Each display cell is discharged to glow by means of opposed cell-by-cell common electrodes and discrete electrodes. One of the four display cells on each row glows in green. In the display panel, the cell-by-cell common electrodes for rendering red and blue that specify each dot are connected to first and second common electrodes extending in columns. The common electrodes for rendering green that specifies each dot and the discrete electrodes therefor are interconnected respectively.

A display panel set forth in the eighth aspect of the present invention is subordinate to the one described in the seventh aspect. Herein, the discrete electrodes included in four display cells for rendering each dot are arranged inside the location of the dot. The discrete electrodes are connected to discrete contacts. The cell-by-cell common electrodes for rendering green are connected to the cell-by-cell common electrodes for rendering green of each adjoining dot which are located on different rows. The cell-by-cell common electrodes for rendering green are connected to common contacts. The discrete contacts and common contacts are arranged alternately in columns.

A driving method for a display panel set forth in the ninth aspect of the present invention is adaptable to a display panel in which each of dots arranged in the form of a matrix is rendered by four display cells arranged in two rows and two columns. Each display cell is discharged to glow by means of opposed cell-by-cell common electrodes and discrete electrodes. One of the four display cells glows in green out of three primary colors. The cell-by-cell common electrodes for rendering red and blue out of three primary colors of each dot are connected to first and second common electrodes extending in columns. The cell-by-cell common electrodes for rendering green that specifies each dot and the discrete electrodes therefor are interconnected respectively. According to the driving method, time domains are determined during which display pulses are applied sequentially to the cell-by-cell common electrodes for rendering red, green, and blue respectively. A unit sequence is completed over the time domains. Discharge control pulses are applied to the discrete electrodes in order to control the luminance of each color.

A driving method for a display panel set forth in the tenth aspect of the present invention is subordinate to the one described in the ninth aspect. Herein, the time interval during which discharge and glow of display cells is sustained or suspended is controlled depending on the pulse widths of the discharge control pulses.

### BRIEF DISCRIPTION OF THE DRAWINGS

FIG. 1 is a plan view showing the structure of a display panel in accordance with the first embodiment including electrodes.

FIG. 2 shows a sequence of applications of pulses for driving the display panel in accordance with the first embodiment;

FIG. 3 is a plan view showing the structure of a display panel in accordance with the third embodiment including electrodes;

FIG. 4 is a plan view showing the structure of the display panel in accordance with the third embodiment including electrodes;

FIG. 5 is a plan view showing the structure of a display panel in accordance with the fifth embodiment including electrodes;

FIG. 6 shows a sequence of applications of pulses for driving the display panel in accordance with the fifth embodiment.

### DESCRIPTION OF THE PREFERRED EMBODIMENTS

First Embodiment

A description will be made of the structure of a display panel in accordance with the first embodiment. Paired cell-by-cell common electrodes and discrete electrodes are arranged on a front glass substrate. The front glass substrate is coated with an insulating material layer. Concave parts are cut in coincident areas on an opposed back glass substrate, whereby discharge spaces of display cells are created. A large number of display cells is arranged. Phosphor layers of three primary colors of red, green, and blue are applied orderly to the bottom of each concave part. When a predetermined voltage is applied to the paired cell-by-cell common electrodes and discrete electrode, plasma is generated in the discharge space of the concave part opposed to the paired cell-by-cell common electrodes and discrete electrode. Ultraviolet rays are absorbed by the phosphor layers. Consequently, a glow of a predetermined color emanates from the concave part through the front glass substrate.

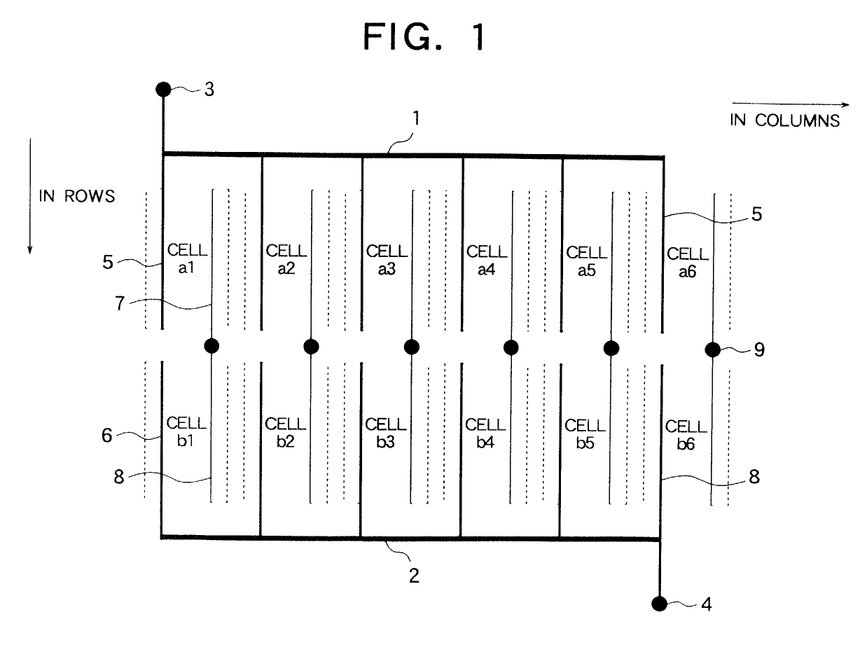

FIG. 1 is a plan view showing the cell-by-cell common electrodes and discrete electrodes in the display panel of the first embodiment. In FIG. 1, reference numerals 1 and 2 denote common electrodes extending in columns. The common electrodes 1 and 2 are connected to common contacts 3 and 4 respectively. The common contacts 3 and 4 are connected to external drive circuits that are not shown. Reference numerals 5 and 6 denote a plurality of cell-by-cell common electrodes extending in rows from the common electrodes 1 and 2 between the common electrodes 1 and 2. Reference numerals 7 and 8 denote discrete electrodes located successively among the adjoining cell-by-cell common electrodes 5 or 6. Reference numerals al to a6 denotes display cells each composed of paired cell-by-cell common electrodes 6 and a discrete electrode 7. Reference numeral 9 denotes a discrete contact located at the center node of the discrete electrodes 7 and 8. The discrete contacts 9 are, as shown in FIG. 1, juxtaposed in a row linearly and led out externally.

Second Embodiment

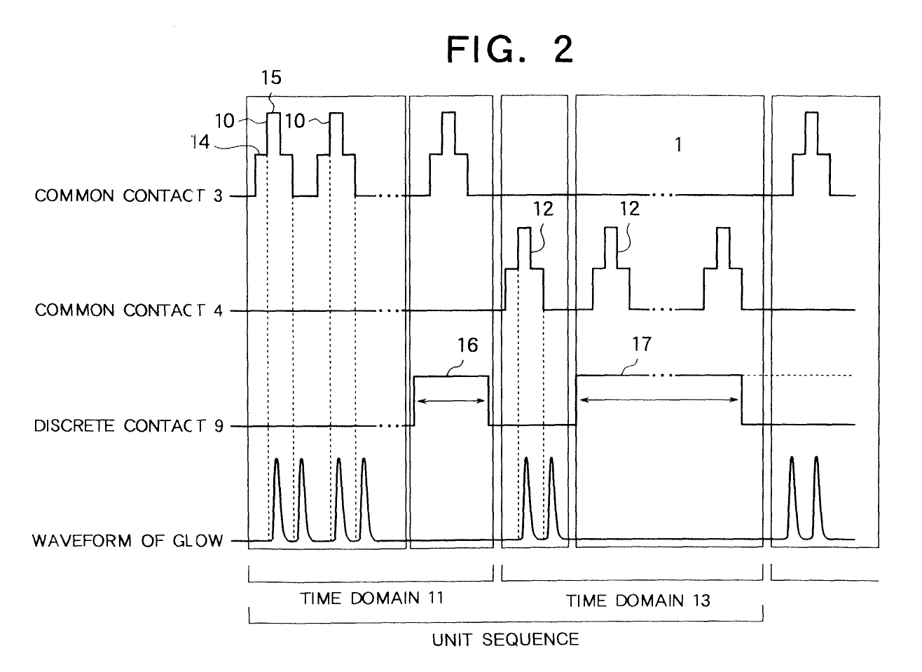

A driving method for a display panel in accordance with the second embodiment will be described in conjunction with FIG. 2. FIG. 2 shows a sequence of applications of pulses required for driving the display panel shown in FIG. 1. As shown in FIG. 2, a time domain 11 and a time domain 13 are defined within the period of a unit sequence. During the time domain 11, a plurality of display pulses 10 is applied to the common contact 3. During the time domain 13, a plurality of display pulses 12 is applied to the common contact 4. The numbers of display pulses applied during the time domains 11 and 13 are determined according to the number of display cells al to a6 and the number of display cells b1 to b6. When the plurality of display pulses 10 is applied to the common contact 3, the plurality of display pulses 10 is applied to the plurality of cell-by-cell common electrodes 5 by way of the common electrode 1 due to the structure shown in FIG. 1. Likewise, when the plurality of display pulses 12 is applied to the common contact 4, the plurality of display pulses 12 is applied to the plurality of cell-by-cell common electrodes 6 by way of the common electrode 2. The display pulses 10 and 12 to be applied to the common electrodes 1 and 2 respectively are, as shown in FIG. 2, composite voltage pulses. The composite voltage pulses each have a second voltage pulse 15 superposed on a first voltage pulse 14 during the duration of the first voltage pulse. The first and second voltage pulses 14 and 15 both exhibit, for example, 160 V. However, the first and second voltage pulses 14 and 15 may exhibit a voltage equal to or higher than a discharge sustaining voltage (130 V or higher) and equal to or lower than a discharge start voltage (220 V). On the other hand, discharge control pulses 16 and 17 like the ones shown in FIG. 2 are applied to the discrete electrodes 7 and 8 through the discrete contacts 9. The discharge control pulses 16 and 17 exhibit a discharge sustaining voltage of, for example, 0 V or a discharge suppressing voltage of, for example, 100 V. For lit cells whose discharge and glow should be sustained, the voltage (0 V) needed for sustaining discharge is applied to the discrete contacts 9. For unlit cells whose discharge and glow should be suppressed, the voltage (100 V) within a discharge suppression domain is applied to the individual contacts 9.

Referring to FIG. 2, the display pulses 10 are applied to the common electrode 1 during the time domain 11. In cells not having the discharge control pulse 16 applied to the discrete electrodes 9 therein (discharge sustaining voltage 0V), the composite voltage pulses are applied to the cell-by-cell common electrodes 5 and discrete electrodes 7. The composite voltage pulses exceed the discharge start voltage. This results in discharge. On the other hand, in display cells having the discharge control pulse 16 applied to the discrete electrodes 7 therein, the potentials at the discrete electrodes 7 rise. A voltage high enough for discharge is not applied to the discrete electrodes 7 and cell-by-cell common electrodes 5. Consequently, discharge is suppressed. The same applied to the time domain 13. During the time domain 11, the display pulses 10 are applied to the cell-by-cell common electrodes 5, and the discharge control pulse 16 is applied to the discrete electrodes 7. Control is thus given to sustain or suppress glow of the display cells a1 to b6. At this time, the display pulses 12 are not applied to the cell-by-cell common electrodes 6. Even if the discharge control pulse 16 is applied to the discrete electrodes 8, a voltage (100 V) lower than the discharge start voltage and discharge sustaining voltage is applied to the cell-by-cell common electrodes 6. The display cells b1 to b6 are therefore not discharged to glow. Glows of the display cells al to a6 and the display cells b1 to b6 exhibit the waveform shown in FIG. 2. As apparent from FIG. 2, when control is given to change the pulse widths of the discharge control pulses 16 and 17 to be applied to the discrete contacts 9, it is controlled whether the display cells should be lit or unlit, that it, glow of the display cells should be sustained or suppressed.

As mentioned above, in the display panel shown in FIG. 1, the time domains 11 and 13 are defined within the period of a unit sequence. So-called two systems including the common electrodes 1 and 2 respectively are actuated during the time domains 11 and 13. Consequently, the display cells a1 to a6 and the display cells b1 to b6 can all be driven and controlled discretely.

Third Embodiment

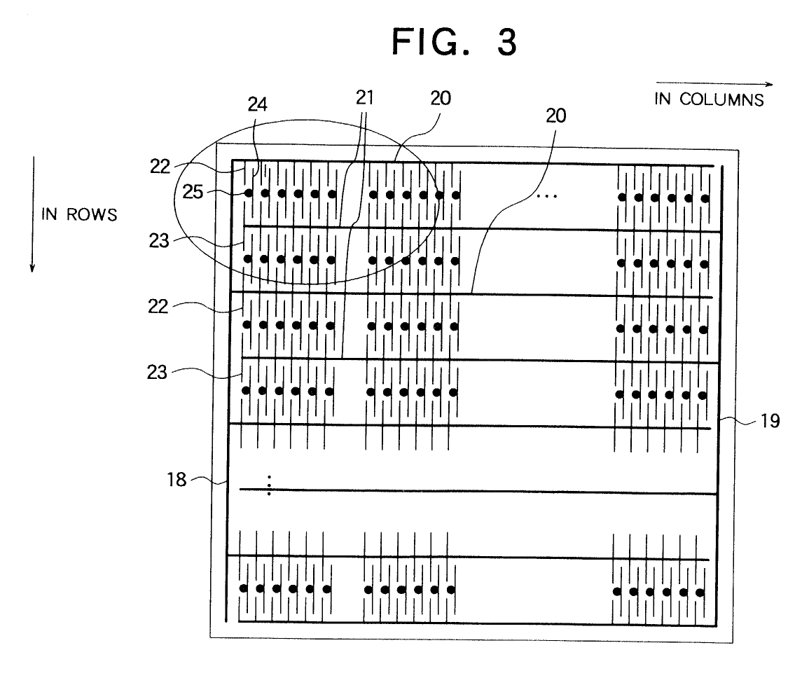

The structure of a display panel in accordance with the third embodiment and a driving method for the display panel will be described below. FIG. 3 is a plan view showing the structure of a display panel in which numerous cells are arranged in rows and columns in the form of a matrix. In FIG. 3, reference numerals 18 and 19 denote common electrode portions extending in rows along both columnar edges of the display panel. Reference numeral 20 denotes a plurality of common electrodes extending in columns from the common electrode portion 18. Reference numeral 21 denotes a plurality of common electrodes extending in columns from the common electrode portion 19. The pluralities of common electrodes 20 and 21 are juxtaposed alternately in rows. Reference numerals 22 and 23 denote numerous cell-by-cell common electrodes extending in rows among the common electrodes 20 and 21. Cell-by-cell common electrodes are extending successively from the common electrodes 21, which extend among the common electrodes 20, on both sides of the common electrodes 20. Reference numeral 24 denotes numerous discrete electrodes extending successively among the cell-by-cell common electrodes 22 and the cell-by-cell common electrodes 23. Reference numeral 25 denotes discrete contacts arranged in columns linearly in the center nodes of the discrete electrodes 24. A cell-by-cell common electrode 22 or 23 and an adjoining discrete electrode 24 constitute each display cell.

A driving method for the display panel shown in FIG. 3 is a method utilizing so-called two systems including the common electrodes 20 and 21 respectively that are linked to the common electrode portions 18 and 19. Similarly to the second embodiment, time domains during which the two systems are actuated separately are defined within the period of a unit sequence. The display cells are thus driven discretely.

In practice, the display panel of the third embodiment visualizes display pixels of, for example, 5 by 5 mm² in size, and has cells of 1.5 by 4 mm² in size. In the display panel, the gap between the cell-by-cell common electrodes 22 and 23 and discrete electrode 24 is 70 μm. Discharge gas (5%-diluted Ne-Xe) of 500 torr is sealed in a discharge space of about 500 μm high.

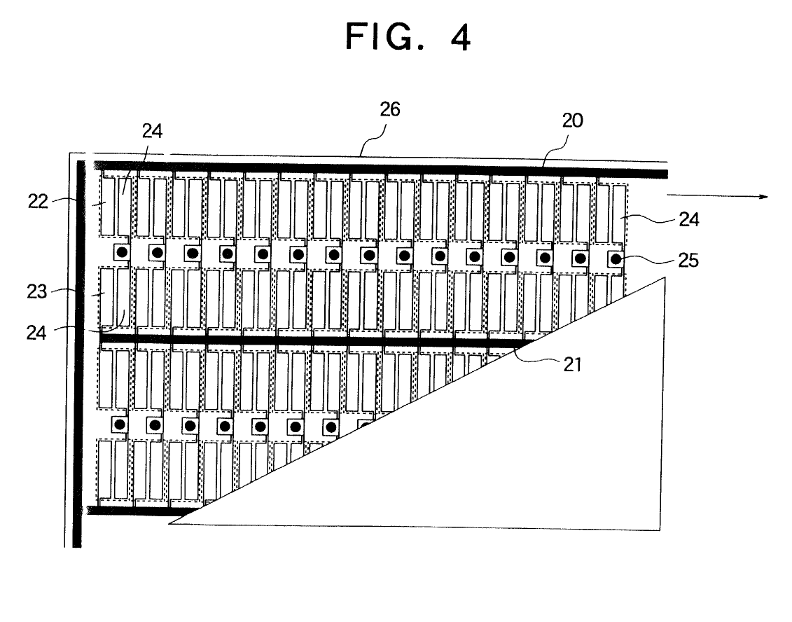

FIG. 4 is a plan view showing the structure of an actually manufactured display panel including the common electrodes 20 and 21 and discrete electrodes 24. The encircled portion of the structure in FIG. 3 is shown in enlargement. In FIG. 4, reference numerals 20 and 21 denote common electrodes. Reference numerals 22 and 23 denote cell-by-cell common electrodes. Reference numeral 24 denotes discrete electrodes mounted on a glass substrate (transparent substrate) 26. The cell-by-cell common electrodes 22 and 23 and the discrete electrodes 24 are realized with transparent electrodes. Reference numeral 25 denotes discrete contacts communicating with the discrete electrodes 24 on both sides thereof. The discrete contacts 25 are realized with pins projecting to the back surface of the display panel. One display cell is composed of a wide cell-by-cell common electrode 22 and discrete electrode 24 or of a cell-by-cell common electrode 23 and discrete electrode 24 which are enclosed with a wavy line in FIG. 4. In the display panel shown in FIG. 4, display cells for rendering 16 dots in width and 16 dots in length are created in a panel of 8 cm wide and long. Each dot is rendered by three adjoining display cells responsible for three primary colors of red (R), green (G), and blue (B). The total number of display cells is 768 and the number of discrete contacts 25 is a half of the number of display cells or 384.

Fourth Embodiment

Next, a description will be made of a method of visualizing gradation in the display panel of the third embodiment shown in FIG. 4. A plurality of display pulses, that is, composite voltage pulses is applied to the common electrodes 20 and 21 (18 and 19) during the associated time domains. The number of display pulses needed for discharge and display can be changed by changing the pulse width of a discharge control pulse to be applied to the discrete electrodes 24. The luminance of a glow is proportional to the number of times of discharge and glow. Luminance and gradation can be visualized according to the number of display pulses applied during a discharge sustaining period which is dependent on the pulse width of a discharge control pulse. In practice, a predetermined number of display pulses, that is, 255 pulses are applied during each time domain. When the discharge control pulse is applied to the discrete electrodes 24 at the rate of one discharge control pulse per 0 to 255 display pulses, the number of times of glow ranges 255 to 0. Gradation of 256 levels can be visualized by changing the number of times of glow.

However, display pulses are applied alternately to the common electrodes 20 and 21 during the associated time domains. During a time domain during which the display pulses are applied to the common electrodes 20, no display pulse is applied to the other common electrodes 21. By the way, a time band defined with several display pulses is created immediately after the transition from the time domain during which no pulse is applied to the time domain during which pulses are applied. During the time band, discharge may become unstable and the intensity of glow may be lowered. A plurality of display pulses is therefore applied to the common electrodes 20 and 21 during the time domains. Consequently, uncertainly in intensity of glow can be stabilized and the intensity of glow can be stabilized. In practice, application of five pulses or more has result in stable glow.

Fifth Embodiment

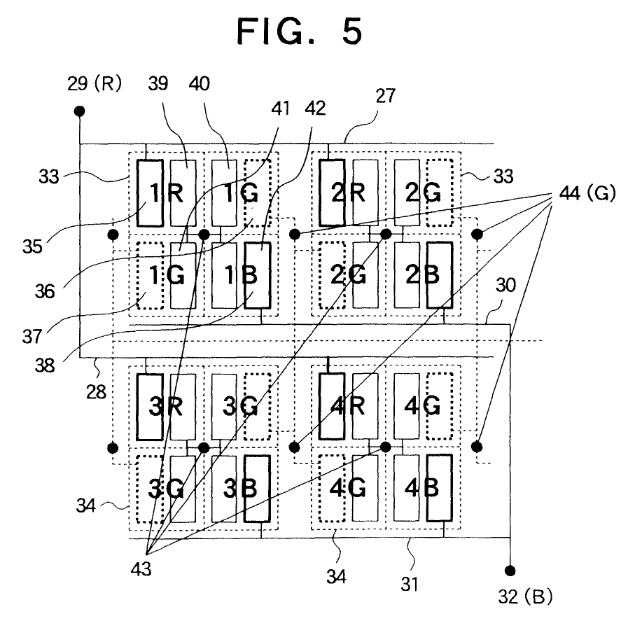

A description will be made of the structure of a display panel in accordance with the fifth embodiment and a driving method for the display panel. FIG. 5 is a plan view showing the structure of the display panel designed for full-color display in which display cells are driven for rendering each of red, green, and green. In FIG. 5, reference numerals 27 and 28 denote common electrodes opposed to each other and extending in rows. The common electrodes 27 and 28 are connected to a common contact 29. Reference numerals 30 and 31 denote common electrodes opposed to each other and extending in rows. The common electrodes 30 and 31 are connected to a common contact 32. In practice, numerous dots to be rendered are arranged in rows and columns. For brevity's sake, in FIG. 5, four dots 33 and 34 to be rendered are arranged in rows and columns between the common electrodes 27 and 30 and between the common electrodes 28 and 31. The dots 33 and 34 are each rendered by four display cells arranged in two rows and two columns. Four display cells for rendering each dot are, as shown in FIG. 5, rendering red, green, and green, and blue respectively (R:G:B=1:2:1). Each cell is composed of paired cell-by-cell common electrodes and a cell-by-cell common electrode. In FIG. 5, reference numerals 35, 36, 37, and 38 denote cell-by-cell common electrodes. The cell-by-cell common electrodes 35 for rendering red are connected to the common electrode 27. The cell-by-cell common electrodes 38 for rendering blue are connected to the common electrode 30. In FIG. 5, reference numerals 39, 40, 41, and 42 denote discrete electrodes for rendering red, green, and green, and blue. The discrete electrodes are interconnected and connected to discrete contacts 43. The cell-by-cell common electrodes 36 for rendering green are, as shown in FIG. 5, connected to cell-by-cell common electrodes for rendering green of each adjoining dot. The cell-by-cell common electrodes 37 for rendering green are connected to cell-by-cell common electrodes for rendering green and adjoining in rows the cell-by-cell common electrodes 37. The cell-by-cell common electrodes for rendering green are connected to common contacts 44 connected to, for example, a driving printed-circuit board. The common contacts 44 for rendering green and the discrete contacts 43 are, as shown in FIG. 5, juxtaposed alternately and linearly. The cell-by-cell common electrodes 35 for rendering red of each dot are connected to the common contact 29. The cell-by-cell common electrodes 38 for rendering blue of each dot are connected to the common contact 32. The cell-by-cell common electrodes 36 and 37 for rendering green of each dot are connected to the common contacts 44. The discrete electrodes 39, 40, 41, and 42 for rendering dots are connected to the discrete contacts 43.

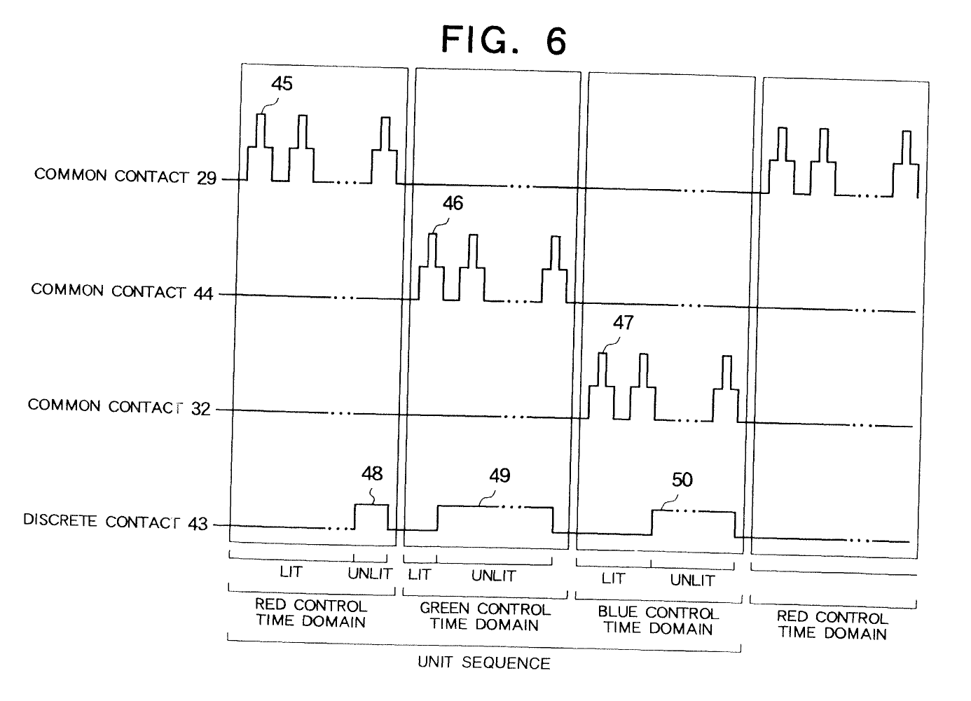

FIG. 6 shows a sequence of applications of pulses employed in a driving method for the display panel shown in FIG. 5. The period of a unit sequence is divided into three time domains of a red time domain, green time domain, and blue time domain. During the red time domain, a plurality of display pulses 45 is applied to only the common contact 29 for rendering red. During the green time domain, a plurality of display pulses 46 is applied to only the common contacts 44 for rendering green. During the blue time domain, a plurality of display pulses 47 is applied to only the common contact 32 for rendering blue. By contrast, discharge control pulses are, for example, as shown in FIG. 6, applied to the discrete contacts 43 during the red, green, and blue time domains. During the red time domain, the display pulses 45 are applied to the common contact 29 and a discharge control pulse 48 is applied to the discrete contacts 43. The pulse width of the discharge control pulse 48 is adjusted in order to control the luminance and gradation of red of each dot. At this time, since no display pulse is applied to the common contacts 32 and 44, display cells for rendering green and blue remain unlit. Similarly, during the green time domain or blue time domain, the display pulses 46 or 47 are applied to the common contacts 44 or 32, and the discharge control pulse 49 or 50 is applied to the discrete contacts 43. The pulse widths of the discharge control pulses 49 and 50 are adjusted in order to visualize the luminance and gradation of green or blue of each dot. At this time, as mentioned above, during the green time domain, no display pulse is applied to the common contacts 29 and 32, and display cells for rendering red and blue remain unlit. During the blue time domain, no display pulse is applied to the common contacts 29 and 44, and display cells for rendering red and green remain unlit. Thus, the three primary colors of red, green, and blue are controlled in luminance by carrying out the unit sequence. Consequently, full-color control is attained dot by dot.

According to the driving method of the fifth embodiment for controlling luminance by actuating so-called three systems, the number of discrete contacts can be further reduced and the display panel can be designed further compactly. The employment of numerous systems leads to a shorter time that can be spent by each system. The number of display pulses capable of being applied during the time therefore decreases. Consequently, the gradation levels are limited or a high-frequency signal is needed for driving. This leads to an increase in cost of circuitry. Time-division control must therefore be attained in consideration of the compact and simple design of the display panel, the operability of circuitry, the number of divisions of a control time during which display cells can be driven, and the cost.

In the foregoing fifth embodiment, two display cells are used to render green of each dot. Since the display cells render green of the same dot, they should be controlled so that their discharge will be sustained or suppressed. The number of common contacts need not be the same as the number of discrete electrodes led out from the discrete contacts. Moreover, in FIG. 5, the cell-by-cell common electrodes for rendering green are connected externally via the common contacts for rendering green. The number of common contacts cannot therefore be decreased. However, when connected even externally, analogous display cells can be driven and controlled all together.

According to the present invention, common contacts are included in a plurality of systems. A plurality of display cells is controlled on a time-division basis using discrete contacts. The display cells can be discretely controlled to discharge and glow. It is unnecessary to control all the display cells at a time. Dependency on the property of each display cell therefore diminishes. A control margin can be expanded and a yield of manufacturing can be improved. Moreover, according to the present invention, when the common contacts included in the plurality of systems are handled all together, discrete electrodes included in a plurality of cells are connected to receive an external signal. This leads to a decrease in number of discrete contacts to be led out from the discrete electrodes. The structure of the display panel can therefore be simplified and designed compactly. The number of electric elements required for driving can be decreased, and the cost of manufacturing can be reduced in terms of the manufacturing process and the expenses of materials. Furthermore, according to the present invention, a discharge control pulse is applied to the discrete contacts included in display cells, of which discharge should be suspended, during a discharge suspension period. The number of times by which the discrete contacts are actuated in order to achieve a unit sequence is thus decreased. Consequently, circuit elements that can withstand only a low voltage may be adopted, and an integrated drive circuit may be employed.

What is claimed is:

1. A display panel including common electrodes extending in columns on a transparent substrate, a plurality of cell-by-cell common electrodes extending in rows from said common electrodes, and discrete electrodes located among said adjoining cell-by-cell common electrodes on the transparent substrate, and having display cells, each of which is discharged to glow by means of paired cell-by-cell common electrode and discrete electrode, set in array, wherein said cell-by-cell common electrodes are interposed between said plurality of adjoining common electrodes, and said discrete electrodes are located successively over said display cells adjoining in rows.

2. The display panel according to claim 1, wherein discrete contacts are located in the center nodes of the successive discrete electrodes, and common contacts are linked to said common electrodes.

3. The display panel according to claim 1, wherein common electrode portions are extending in rows along both columnar edges of the transparent substrate, and common electrodes are connected alternately to these common electrode portions.

4. A driving method for a display panel including one common electrode and the other common electrode opposed to each other and extending in columns, a plurality of cell-by-cell common electrodes extending in rows from the one common electrode and the other common electrode, and a plurality of discrete electrodes extending in rows among the cell-by-cell common electrodes, having a plurality of display cells, each of which is discharged to glow by means of paired cell-by-cell common electrode and a discrete electrode, set in array, and having the discrete electrodes located successively over cells adjoining in rows, wherein one time domain and the other time domain during which display pulses are applied sequentially to the one common electrode and the other common electrode are determined in order to complete a unit sequence, discharge control pulses are applied to the discrete electrodes, and the display cells on the plurality of rows are thus lit or unlit.

5. The driving method for a display panel according to claim 4, wherein said display pulses are composite voltage pulses that get higher than a discharge start voltage after having a voltage pulse equal to or lower than the discharge start voltage superposed thereon during the pulse duration of the voltage pulse, and the pulse widths of said discharge control pulses are controlled in order to control whether the display cells should be unlit.

6. The driving method for a display panel according to claim 5, wherein a plurality of said display pulses is applied during each of the time domains during which the display pulses are applied to the one common electrode or the other common electrode.

7. A display panel in which each of dots arranged in a form of a matrix is rendered by four display cells arranged in two rows and two columns, each display cell is discharged to glow by means of opposed cell-by-cell common electrodes and discrete electrodes, and one of the four display cells on each row glows in green, wherein cell-by-cell common electrodes for rendering red and blue of each dot are connected to first and second common electrodes extending in columns, and said cell-by-cell common electrodes for rendering green of each dot and said discrete electrodes therefor are interconnected respectively.

8. The display panel according to claim 7, wherein: discrete electrodes in four display cells for rendering each dot are arranged mutually adjacently inside the location of the dot, and connected to discrete contacts; cell-by-cell common electrodes for rendering green are connected to cell-by-cell common electrodes for rendering green of each adjoining dot which are located on different rows, and also connected to common contacts; and said discrete contacts and common contacts are arranged alternately in columns.
